(19) United States
(12) Patent Application Publication
(10) Pub. No.: US 2026/0169168 A1
(43) Pub. Date: Jun. 18, 2026

(54) SYSTEMS AND METHODS FOR DETECTING AND CLASSIFYING AN OBJECT

(71) Applicant: Ford Global Technologies, LLC, Dearborn, MI (US)

(72) Inventors: Sina Sadeghian, Livonia, MI (US); Mario Anthony Santillo, Canton, MI (US); Kyle Richard Post, Dearborn, MI (US); Mark Douglas Malone, Canton, MI (US)

(73) Assignee: Ford Global Technologies, LLC, Dearborn, MI (US)

(21) Appl. No.: 18/986,085

(22) Filed: Dec. 18, 2024

(51) Int. Cl. G01S 17/89; G05D 1/622; G05D 101/00; G05D 107/80; G06V 10/25; G06V 10/764; G06V 10/80; G06V 20/58

(52) U.S. Cl. CPC G01S 17/89; G05D 1/622; G06V 10/25; G06V 10/764; G06V 10/809; G06V 20/58; G05D 2101/22; G05D 2107/80

(57) ABSTRACT

A method includes obtaining a plurality of sensor-based map associated with a marshaling environment, the concatenation of each sensor-based map of the plurality of sensor-based maps, the detection of one or more classified objects in the marshaling environment and one or more unclassified objects in the marshaling environment, the generation of an occupancy map, and the integration of the occupancy map with a vehicle control system associated with an automated vehicle.

### FIELD

The present disclosure relates to the detection and classification of objects, and more particularly, to the detection and classification of one or more objects within a marshaling environment.

### BACKGROUND

The statements in this section merely provide background information related to the present disclosure and may not constitute prior art.

Traditional safety mechanisms utilized within industrial environments typically rely upon single sensor systems or multiple camera setups to monitor the industrial environments that face one or more limitations. For example, single sensor systems can be prone to blind spots, misalignment, and inconsistencies in data fusion. As another example, camera-based systems can be affected by environmental interference such as poor lighting, dust, and weather conditions. As a further example, reliance on human monitoring of camera-based systems can result in errors, delayed responses, and oversights. As an additional example, current single sensor systems and/or multiple camera setups can also be associated with operational inefficiencies, lack of adaptability, and can result in inadequate responses to complex interactions.

The present disclosure addresses these and other issues related to the detection and classification of objects within an industrial setting.

### SUMMARY

This section provides a general summary of the disclosure and is not a comprehensive disclosure of its full scope or all of its features.

The present disclosure provides a method comprising: obtaining, by plurality of sensors of an infrastructure system, a plurality of sensor-based maps associated with a marshaling environment; concatenating each sensor-based map of the plurality of sensor-based maps; detecting, by one or more algorithms associated with the infrastructure system, one or more classified objects in the marshaling environment and one or more unclassified objects in the marshaling environment based on the concatenation of each sensor-based map of the plurality of sensor-based maps; generating an occupancy map based on object data associated with each of the one or more classified objects and the one or more unclassified objects; and integrating the occupancy map with a vehicle control system associated with an automated vehicle, wherein the integration of the occupancy map with the vehicle control system enables the infrastructure system to autonomously control the automated vehicle in real-time; further comprising: determining a desired spatial configuration corresponding to a field of view associated with each sensor of the plurality of sensors and an optimal placement of each sensor of the plurality of sensors; and calibrating each sensor of the plurality of sensors based on the desired spatial configuration and the optimal placement of each sensor of the plurality of sensors; further comprising: identifying one or more zones of the marshaling environment; and filtering a field of view associated with each sensor of the plurality of sensors based on the identification of the one or more zones of the marshaling environment; wherein each sensor-based map of the plurality of sensor-based maps is based on data obtained from a different sensor of the plurality of sensors; wherein the concatenation of each sensor-based map of the plurality of sensor-based maps comprises: applying a filter to one or more data points associated with each sensor-based map of the plurality of sensor-based maps, wherein the filter includes a voxel filter, a height filter, a regional filter, a ground segmentation filter, a clustering filter, or a combination thereof; wherein the concatenation of each sensor-based map of the plurality of sensor-based maps comprises: merging one or more data points associated with each sensor-based map of the plurality of sensor-based maps; and forming a comprehensive view of the marshaling environment based on the merging of the one or more data points associated with each sensor-based map of the plurality of sensor-based maps; wherein the detection of each of the one or more classified objects and the one or more unclassified objects further comprises: generating one or more virtual bounding boxes corresponding to each of the one or more classified objects and the one or more unclassified objects; and wherein the generation of the occupancy map further comprises: merging the one or more classified objects with the one or more unclassified objects.

The present disclosure provides a system comprising: an infrastructure system configured to: obtain, from a plurality of sensors of the infrastructure system, a plurality of sensor-based maps associated with a marshaling environment, concatenate each sensor-based map of the plurality of sensor-based maps, detect, by one or more algorithms associated with the infrastructure system, one or more classified objects in the marshaling environment and one or more unclassified objects in the marshaling environment based on the concatenation of each sensor-based map of the plurality of sensor-based maps, generate an occupancy map based on object data associated with each of the one or more classified objects and the one or more unclassified objects, and integrate the occupancy map with a vehicle control system associated with an automated vehicle, wherein the integration of the occupancy map with the vehicle control system enables the infrastructure system to autonomously control the automated vehicle in real-time during marshaling of the automated vehicle; and the automated vehicle configured to: receive, from the infrastructure system, one or more marshaling commands associated with the autonomous control of the automated vehicle, and proceed to a waypoint within the marshaling environment based on the one or more marshaling commands; wherein the infrastructure system is further configured to: determine a desired spatial configuration corresponding to a field of view associated with each sensor of the plurality of sensors and an optimal placement of each sensor of the plurality of sensors; and calibrate each sensor of the plurality of sensors based on the desired spatial configuration and the optimal placement of each sensor of the plurality of sensors; wherein the infrastructure system is further configured to: identify one or more zones of the marshaling environment; and filter a field of view associated with each sensor of the plurality of sensors based on the identification of the one or more zones of the marshaling environment; wherein each sensor-based map of the plurality of sensor-based maps is based on data obtained from a different sensor of the plurality of sensors; wherein the infrastructure system configured to concatenate each sensor-based map of the plurality of sensor-based maps is further configured to: apply a filter to one or more data points associated with each sensor-based map of the plurality of sensor-based maps, wherein the filter includes a voxel filter, a height filter, a regional filter, a ground segmentation filter, a clustering filter, or a combination thereof; wherein the infrastructure system configured to concatenate each sensor-based map of the plurality of sensor-based maps is further configured to: merge one or more data points associated with each sensor-based map of the plurality of sensor-based maps; and form a comprehensive view of the marshaling environment based on the merging of the one or more data points associated with each sensor-based map of the plurality of sensor-based maps; wherein the infrastructure system configured to detect each of the one or more classified objects and the one or more unclassified objects is further configured to: generate one or more virtual bounding boxes corresponding to each of the one or more classified objects and the one or more unclassified objects; and wherein the infrastructure system configured to generate the occupancy map is further configured to: merge the one or more classified objects with the one or more unclassified objects.

The present disclosure provides one or more non-transitory computer-readable media storing processor-executable instructions that, when executed by at least one processor, cause the at least one processor to: obtain a plurality of sensor-based maps associated with a marshaling environment; concatenate each sensor-based map of the plurality of sensor-based maps; detect one or more classified objects in the marshaling environment and one or more unclassified objects in the marshaling environment based on the concatenation of each sensor-based map of the plurality of sensor-based maps; generate an occupancy map based on object data associated with each of the one or more classified objects and the one or more unclassified objects; and integrate the occupancy map with a vehicle control system associated with an automated vehicle, wherein the integration of the occupancy map with the vehicle control system enables an infrastructure system to autonomously control the vehicle in real-time; wherein the at least one processor caused to concatenate each sensor-based map of the plurality of sensor-based maps is further caused to: merge one or more data points associated with each sensor-based map of the plurality of sensor-based maps; and form a comprehensive view of the marshaling environment based on the merging of the one or more data points associated with each sensor-based map of the plurality of sensor-based maps; wherein the at least one processor caused to concatenate each sensor-based map of the plurality of sensor-based maps is further caused to: apply a filter to one or more data points associated with each sensor-based map of the plurality of sensor-based maps, wherein the filter includes a voxel filter, a height filter, a regional filter, a ground segmentation filter, a clustering filter, or a combination thereof; and wherein the at least one processor caused to detect each of the one or more classified objects and the one or more unclassified objects is further caused to: generate one or more virtual bounding boxes corresponding to each of the one or more classified objects and the one or more unclassified objects.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating an example computer system in accordance with one or more embodiments of the present disclosure;

FIG. 2A is a block diagram of a system to detect and/or classify one or more objects in accordance with one or more embodiments of the present disclosure;

FIG. 2B is an example process-flow diagram illustrating the detection and/or classification of the one or more objects in accordance with one or more embodiments of the present disclosure;

FIG. 2C is another example process-flow diagram illustrating the detection and/or classification of the one or more objects in accordance with one or more embodiments of the present disclosure; and

FIG. 3 is a flowchart illustrating an example method for detecting and/or classifying the one or more objects in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for the detection and/or classification of one or more objects within a marshaling environment through the use of one or more filtering techniques and processes associated with one or more images of the marshaling environment. In one or more examples, a plurality of Light Detection and Ranging (LIDAR) sensors distributed within the marshaling environment is used to provide comprehensive coverage and enhanced accuracy associated with monitoring the marshaling environment. For example, by using a multi-LIDAR collaboration system (e.g., the plurality of LIDAR sensors) rather than single sensor systems, a 360-degree view of the marshaling environment is provided that provides monitoring capability to every area within the marshaling environment. By contrast, and for example, the single sensor systems often suffer from blind spots and limited coverage areas. As another example, by using the multi-LIDAR collaboration system and combining data from multiple LIDAR units, object detection accuracy and classification is enhanced. By contrast, and for example, the single sensor systems may not detect and/or classify small and/or fast-moving objects that the multi-LIDAR collaboration system otherwise would detect and classify.

In one or more examples, the multi-LIDAR collaboration system provides a means for faster (e.g., immediate) detection and response to any obstacles and/or changes within the marshaling environment by integrating data from multiple LIDAR sensors in real-time, thereby creating a unified and detailed three-dimensional view of the marshaling environment. As another example, the multi-LIDAR collaboration system provides clean and reliable data by employing various noise filtering algorithms (e.g., voxel filters, height filters, regional filters, ground segmentation filters, clustering filters, etc.). By employing the various noise filtering algorithms, false positives associated with an object within the marshaling environment are reduced, thereby enhancing system reliability.

In one or more examples, the multi-LIDAR collaboration system maintains high performance across diverse conditions, thereby providing consistent safety and efficiency related to the marshaling environment. By contrast, traditional systems (e.g., systems that rely solely on cameras) can be influenced by environmental factors such as lighting, dust, weather, etc. In another example, the multi-LIDAR collaboration system is configured to adapt to changes (e.g., new obstacles or rearranged layouts) in the marshaling environment without extensive recalibration or reprogramming, which results in more continuous operation in dynamic settings.

In one or more examples, the multi-LIDAR collaboration system provides a means for accurate real-time detection and/or classification of objects (e.g., vehicles, pedestrians, etc.), thereby significantly reducing a number of accidents within a high-density environment that corresponds to dynamic industrial settings. As another example, the multi-LIDAR collaboration system provides a means for precise monitoring and quick response capabilities that allow for the prevention of traffic bottlenecks and operational inefficiencies, thereby leading to smoother and enhanced efficiency related to marshaling operations.

In one or more examples, the multi-LIDAR collaboration system provides an effective implementation within existing vehicle control systems. For example, the implementation of the multi-LIDAR collaboration system within existing vehicle control systems is provided without the need for a complete overhaul while enhancing one or more capabilities of the vehicle control system. As another example, the multi-LIDAR collaboration system is scalable, allowing for the system to be expanded to cover larger areas and/or more complex environments, thereby making the system suitable for various industrial applications.

In one or more examples, the multi-LIDAR collaboration system accurately identifies and creates bounding boxes around objects by using one or more three-dimensional detection algorithms, thereby providing an enhanced means for tracking moving and/or static objects within the marshaling environment. As another example, the multi-LIDAR collaboration system provides a simplified and effective representation of the marshaling environment by converting the three-dimensional data to a two-dimensional occupancy map, thereby aiding in real-time monitoring and management that enhances response strategies and/or safety protocols.

In one or more examples, the multi-LIDAR collaboration system includes one or more redundancies in both hardware and software components that provides for continuous operation within the marshaling environment regardless of whether each aspect involved in the operation is functional. As an example, continuous operation allows for maintaining safety and/or operational efficiencies in the marshaling environment as well as other industrial environments.

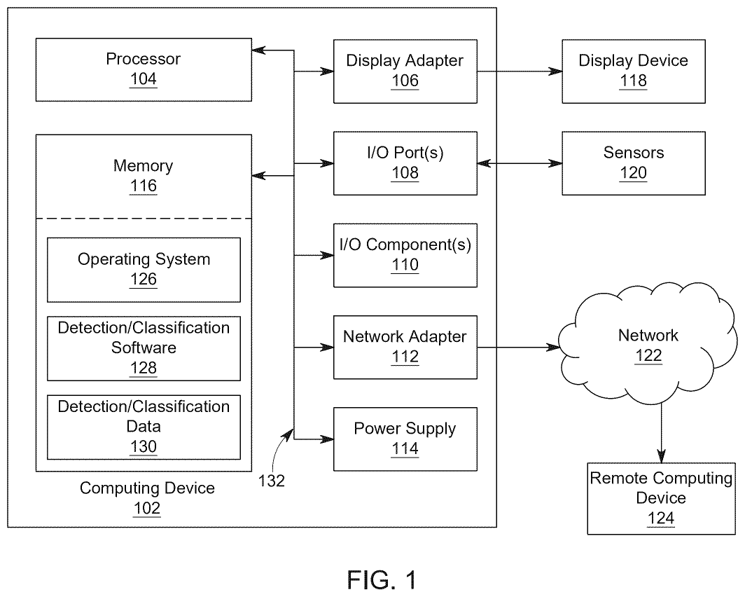

FIG. 1 illustrates an operating environment, such as a computer system, that facilitates the performance of one or more systems and methods related to the detection and/or classification of one or more objects within a marshaling environment, as is described herein. For example, the marshaling environment can represent a plant marshaling setting, an automated charging setting, a depot marshaling setting, an underground parking setting, among others. However, it is understood that the systems and methods described herein may be applicable in any setting wherein the detection and/or classification of one or more objects is capable of being implemented therein. More specifically, the systems and methods described herein can be implemented using a computing device 102. For example, the computing device 102 can be a personal computer, a desktop, a laptop, a tablet, a hand-held computer, a server, a workstation, a mainframe, a wearable computer, a supercomputer, or a combination thereof. However, it is understood that the aforementioned examples of the computing device 102 is non-exhaustive and the computing device 102 can be any type of processing or computing device. The computing device 102 generally includes a processor 104, a display adapter 106, one or more input/output port(s) 108, one or more input/output component(s) 110, a network adapter 112, a power supply 114, and a memory 116. However, it is understood that the computing device 102 can include any additional components therein and is not required to include any of the listed components (e.g., the processor 104, the display adapter 106, the one or more input/output port(s) 108, the one or more input/output component(s) 110, the network adapter 112, the power supply 114, and the memory 116).

The processor 104 is configured to provide instructions to the computing device 102 so that the computing device 102 can process one or more tasks including the implementation of a software program to perform one or more operations such as, but not limited to, concatenating a plurality of sensor-based maps so that one or more objects can be detected and an occupancy map can ultimately be generated, as described in more detail herein. It is also understood that the computing device 102 may include any number of processors 104 therein. The display adapter 106 can be a graphics card or a video board that provides the computing device 102 with a capability to display content on a display device 118. For example, the display device 118 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 118 is non-exhaustive and that the display device 118 can be any type of device capable of providing a visual display.

The input/output port(s) 108 provide a number of interfaces (e.g., sockets) for one or more cables to connect to the computing device 102. It is understood that there may be any number of input/output port(s) 108 on the computing device 102. For example, the input/output port(s) 108 provides a means for the computing device 102 to receive signals and/or data from an external device connected to the computing device 102 via the one or more cables such as, but not limited to, a plurality of infrastructure-based sensors 120. For example, the plurality of sensors 120 represent one or more LIDAR sensors. However, it is understood that the plurality of sensors 120 may be any type of sensor such as, but not limited to, one or more cameras, radar, and/or ultrasonic devices configured to monitor the movement of one or more automated vehicles, and/or other objects, through the marshaling environment. As another example, the input/output port(s) 108 provide a means for the computing device 102 to send signals and/or data to an external device connected to the computing device 102 via the one or more cables. The input/output component(s) 110 can include one or more components that support the input/output port(s) 108 such as, but not limited to, a switch, a push button, a pressure mat, a float switch, a keypad, a radio receive, or a combination thereof.

The network adapter 112 can be any type of network interface controller that is configured to provide a means for communicating over a network 122 with another computing device, such as a remote computing device 124. In one or more examples, the remote computing device 124 can be a user device such as a cellular-phone, a smartphone, a tablet, a laptop, or a combination thereof. The power supply 114 is configured to convert alternating high voltage current (e.g., AC) into direct current (e.g., DC) to provide power to the other components (e.g., the processor 104, the display adapter 106, the one or more input/output port(s) 108, the one or more input/output component(s) 110, the network adapter 112, and the memory 116) of the computing device 102.

Additionally, the memory 116 can be a mass storage device and/or a system memory such as a hard disk drive, a memory card, a solid-state drive, random access memory (RAM), or a combination thereof. The memory 116 is configured to provide storage for instructions and data associated with the operation of the computing device 102. In one or more examples, the data associated with the operation of the computing device 102 can include historical data related to the marshaling environment that can serve as a foundational baseline for the processor 104 to determine what actions or instances related to the marshaling environment is expected or not expected. As an example, the historical data can serve as a bases for an establishment of one or more thresholds, as is described herein. The memory 116 can generally include an operating system 126, detection/classification software 128, and detection/classification data 130. For example, the operating system 126 is configured to manage and/or process any of the data and/or instructions associated with the detection/classification software 128 and/or detection/classification data 130, as described in more detail herein.

Furthermore, a system bus 132 is also included within the computing device 102 that is configured to couple each of the various components (e.g., the processor 104, the display adapter 106, the one or more input/output port(s) 108, the one or more input/output component(s) 110, the network adapter 112, the power supply 114, and the memory 116) of the computing device 102. It is also understood that each of the components of the computing device 102, and the functionality associated with each of the components of the computing device 102, may be implemented within the remote computing device 124. While the operating environment illustrated within FIG. 1 depicts a particular configuration associated with at least the computing device 102, the network 122, and the remote computing device 124, it is understood that the operating environment may be configured in any way.

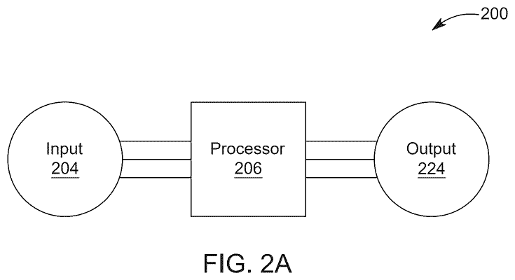

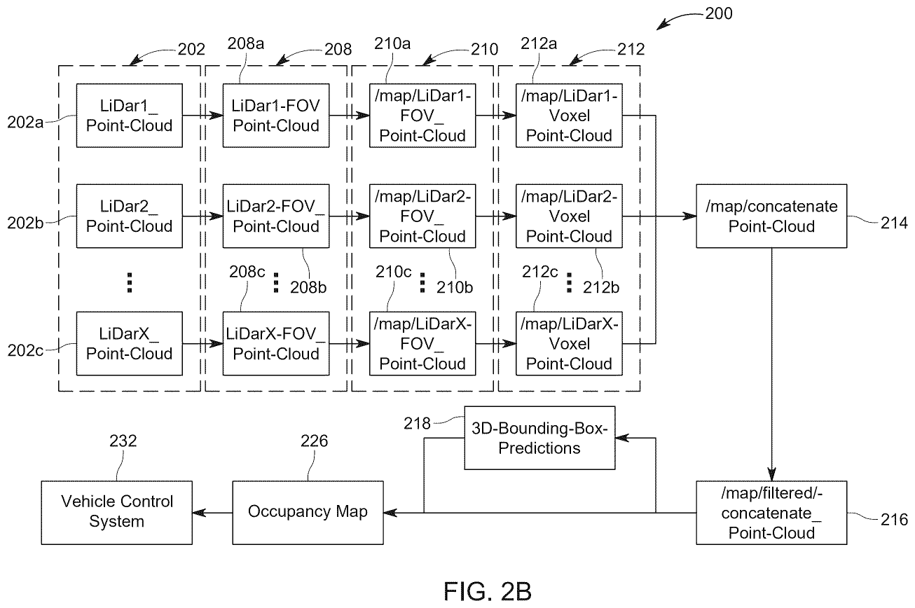

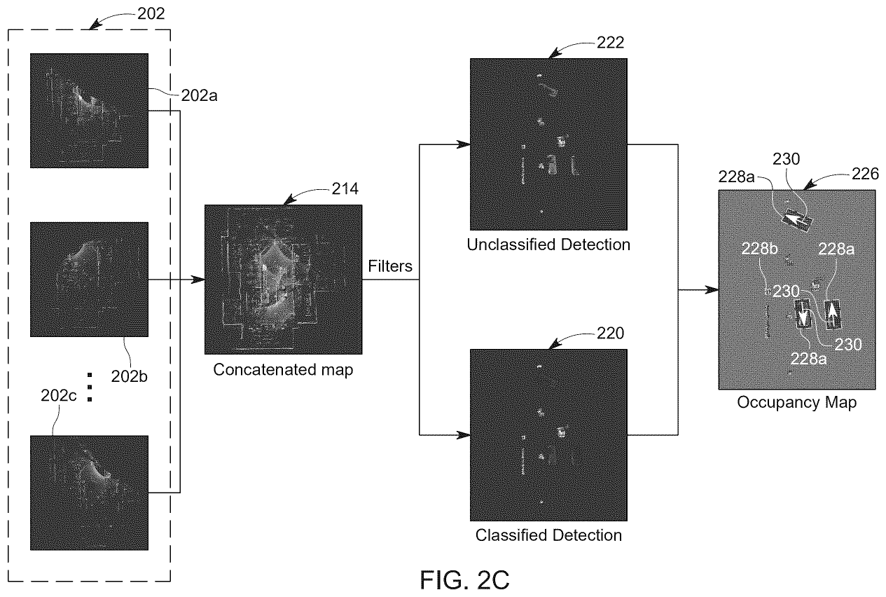

In one or more embodiments, a system 200 (e.g., as depicted in FIGS. 2A-2C and which may be embodied as or form part of the computing device 102) is configured to obtain one or more data sets at operation 202 as an input 204. In one or more embodiments, the one or more data sets is obtained (e.g., captured) by the plurality of sensors 120 of an infrastructure system (not shown). In one or more examples, the one or more data sets can correspond to a LIDAR point cloud. As another example, each sensor of the plurality of sensors 120 can capture respective data sets that correspond to a field of view associated with each respective sensor of the plurality of sensors 120. For example, a first LIDAR point cloud 202a can correspond to a field of view of a first sensor, a second LIDAR point cloud 202b can correspond to a field of view of a second sensor, and a third LIDAR point cloud 202c can correspond to a field of view of a third sensor. In one or more embodiments, the field of view of any sensor of the plurality of sensors 120 can overlap. For example, the first LIDAR point cloud 202a can be obtained by both the first sensor and the second sensor of the plurality of sensors 120. As another example, the third LIDAR point cloud 202c can be obtained by both the third sensor and the second sensor of the plurality of sensors 120. As yet another example, the second LIDAR point cloud 202b can be obtained by any of the first sensor, the second sensor, and/or the third sensor of the plurality of sensors 120. It is understood that the one or more data sets can provide enhanced detail and accuracy that corresponds with occupancy maps associated with a manufacturing facility that can allow for precise spatial configuration and/or optimal placement of each sensor of the plurality of sensors 120 throughout the manufacturing facility.

The input 204 can be utilized as a basis for a processor 206 (e.g., embodied as the processor 104) to perform one or more transformational steps associated with the detection and/or classification of the one or more data sets. Specifically, the processor 206 is configured to calibrate and/or transform the one or more data sets at operation 208, optimize the field of view of any sensor of the plurality of sensors 120 at operation 210, filter the one or more data sets at operation 212, concatenate the one or more data sets at operation 214, filter the concatenated one or more data sets at operation 216, generate one or more bounding boxes around the one or more objects at operation 218, generate an occupancy map at operation 220, and/or integrate the occupancy map at operation 222. While a number of filters are described herein, it is understood that any filter may be used at any of the transformational steps and are not limited to the filters that are specifically mentioned herein.

In one or more embodiments, the processor 206 is configured to calibrate and/or transform each sensor of the plurality of sensors 120 at operation 208. In one or more examples, the processor 206 is configured to calibrate and/or transform each sensor of the plurality of sensors 120 by instructing a service entity (e.g., a person, a robot, etc.) to physically adjust aspects of each sensor of the plurality of sensors 120 such as, but not limited to, a scan angle, a tilt, and/or a field of view associated with each sensor of the plurality of sensors 120. As another example, the processor 206 is configured to calibrate and/or transform each sensor of the plurality of sensors 120 via one or more software updates that can adjust aspects of each sensor of the plurality of sensors 120 such as, but not limited to, a scan angle, a scan frequency, a pulse rate, beam divergence, laser power, a field of view, and/or a number of laser beams associated with each sensor of the plurality of sensors 120.

In one or more examples, the calibration and/or the transformation made to the first sensor can affect a first field of view 208a associated with the first LIDAR point cloud 202a. As another example, the calibration and/or the transformation made to the second sensor can affect a second field of view 208b associated with the second LIDAR point cloud 202b. As yet another example, the calibration and/or the transformation made to the third sensor can affect a third field of view 208c associated with the third LIDAR point cloud 202c. It is understood that any of the fields of view 208a-208c can be modified by, but not limited to, adjusting the field of view of any of the sensors of the plurality of sensors 120, for example. It is also understood that the calibration and/or the transformation of the one or more data sets at operation 208 can provide, but is not limited to, data alignment associated with an enhanced reliability and accuracy associated with the detection and/or classification of the one or more objects that may be present within the manufacturing facility.

In one or more embodiments, the processor 206 is also configured to optimize the field of view of any sensor of the plurality of sensors 120 at operation 210. In one or more examples, the processor 206 is configured to optimize the field of view of any sensor of the plurality of sensors 120 by applying a field of view filter to any of the one or more data sets, thereby transforming each of the one or more data sets to a global map representative of the marshaling environment. In one or more examples, the field of view filter can be applied manually or by any machine learning (e.g., supervised, semi-supervised, or unsupervised) means to adjust the field of view of any of the one or more data sets. As another example, the field of view filter applied to any of the one or more data sets can focus on specific areas within the one or more data sets, such as a marshaling area or any other area within the marshaling environment. For example, a level of adjustment to the field of view of any of the one or more data sets can be determined by a person. As a further example, the processor 206 is configured to utilize any form of neural networking or deep learning modeling to compare historical data associated with the field of view of any sensor of the plurality of sensors 120 to a current data set associated with the field of view of any sensor of the plurality of sensors 120. For example, the comparison of the historical data and the current data set can be indicative of a most desired field of view associated with a typical data set associated with a typical travel path utilized within the marshaling environment.

In one or more examples, the optimization of the field of view made to the first sensor can affect a fourth field of view 210a associated with the first LIDAR point cloud 202a. It is understood that the fourth field of view 210a is a further enhanced version of the first field of view 208a. As another example, the optimization of the field of view made to the second sensor can affect a fifth field of view 210b associated with the second LIDAR point cloud 202b. It is understood that the fifth field of view 210b is a further enhanced version of the second field of view 208b. As yet another example, the optimization of the field of view made to the third sensor can affect a sixth field of view 210c associated with the third LIDAR point cloud 202c. It is understood that the sixth field of view 210c is a further enhanced version of the third field of view 208c. It is also understood that the field of view filter applied to any of the one or more data sets can cause unnecessary data to be eliminated from the one or more data sets, which can result in enhanced processing efficiency associated with the one or more data sets. As an example, the unnecessary data can include, but is not limited to, data outside the field of view of any of the sensors of the one or more sensors 120.

In one or more embodiments, the processor 206 is further configured to apply a voxel filter to any of the one or more data sets at operation 212. In one or more examples, the voxel filter applied to any of the one or more data sets can be applied manually or by any machine learning (e.g., supervised, semi-supervised, or unsupervised) means to filter any of the one or more data sets.

As an example, the application of the voxel filter to any of the one or more data sets is utilized to reduce a number of points present within any of the LIDAR point clouds 202a-202c associated with any of the one or more data sets while preserving an overall structure and/or features of the marshaling environment captured as part of the one or more data sets. As another example, the application of the voxel filter causes a division of the space (e.g., the marshaling environment) depicted in any of the one or more data sets into a three-dimensional grid of equally sized cubes (e.g., voxels). A single point (e.g., from the LIDAR point clouds 202a-202c) is positioned within each voxel while all other points not positioned within a voxel are discarded, for example. It is understood that the application of the voxel filter can reduce data density as well as computational load, which enhances processing speed and efficiency. In one or more examples, a first voxel filter 212a can be applied to the fourth field of view 210a associated view 210a associated with the first LIDAR point cloud 202a. As another example, a second voxel filter 212b can also be applied to the fifth field of view 210b associated with the second LIDAR point cloud 202b. As yet another example, a third voxel filter 212c can further be applied to the sixth field of view 210c associated with the third LIDAR point cloud 202c.

In one or more embodiments, the processor 206 is further configured to concatenate the one or more data sets at operation 214. In one or more examples, the processor 206 is configured to concatenate the one or more data sets by merging point cloud data from any of the LIDAR point clouds 202a-202c to generate a comprehensive view of the marshaling environment.

In one or more embodiments, the processor 206 is also configured to filter the concatenated one or more data sets at operation 216. In one or more examples, the processor 206 is configured to filter the concatenated one or more data sets by applying any of a height filter, a regional filter, a ground segmentation filter, and/or a clustering filter to any of the concatenated one or more data sets. It is understood that the height filter, the regional filter, the ground segmentation filter, and/or the clustering filter can be applied to any of the fields of view (e.g., 210a-210c) associated with any of the LIDAR point clouds (202a-202c) separately or in combination with one another. It is understood that applying multiple layers and/or types of filtering (e.g., noise filtering) can enhance data fidelity and object detection. In one or more examples, any of the filters applied to any of the one or more data sets can be applied manually or by any machine learning (e.g., supervised, semi-supervised, or unsupervised) means to filter any of the one or more data sets.

As another example, the application of the height filter to any of the one or more data sets is utilized to remove outlier points present within any of the LIDAR point clouds 202a-202c that correspond to a height that is either too high and/or too low relative to a predefined reference plane and associated with any of the one or more data sets. For example, while the reference plane can correspond to a ground level of the marshaling environment, the reference plane can correspond to any area of the marshaling environment. As yet another example, a determination of whether the outlier points are too high or too low can be made by any form of neural networking or deep learning modeling based on whether a threshold is exceeded. As a further example, the threshold can be predefined and can be representative of any acceptable range associated with a height that the outlier points can be from the reference plane. It is understood that the application of the height filter can eliminate points (e.g., the outlier points) causing the data to focus on the marshaling area. However, it is understood that the application of the height filter can eliminate points (e.g., the outlier points) causing the data to focus on any area.

As another example, the application of the regional filter to any of the one or more data sets is utilized to isolate a region of interest within any of the LIDAR point clouds 202a-202c associated with any of the one or more data sets so that one or more specific areas within the marshaling environment can be focused upon. As another example, one or more spatial boundaries (e.g., one or more bounding boxes) can be generated to define the one or more specific areas within the marshaling environment and/or one or more objects within the marshaling environment. As an additional example, the one or more spatial boundaries are generated by any form of neural networking or deep learning modeling. It is understood that the application of the regional filter causes a removal of points that are positioned outside of the one or more spatial boundaries, which enhances accuracy while reducing unnecessary computations based on processing only data within the one or more specific areas. However, it is understood that data located outside of the one or more specific areas can also be processed in some examples.

In one or more examples, the one or more spatial boundaries reflect an accurate and to-scale sizing associated with any of the one or more objects such as, but not limited to, an automated vehicle. For example, the one or more spatial boundaries can reflect an accurate and to-scale sizing associated with any of the one or more objects based only on partial points associated with the object using any form of neural networking or deep learning modeling. In other words, a complete processing of the points associated with the object is not required for the one or more spatial boundaries to reflect an accurate and to-scale sizing associated with any of the one or more objects.

As yet another example, the application of the ground segmentation filter to any of the one or more data sets is utilized to separate points from any of the LIDAR point clouds 202a-202c associated with a ground of the marshaling environment from points from any of the LIDAR point clouds 202a-202c that are not associated with the ground of the marshaling environment. For example, the one or more points not associated with the ground of the marshaling environment can represent, but is not limited to, one or more vehicles, pedestrians, and/or other objects within the marshaling environment. As an example, the application of the ground segmentation filter is performed using one or more algorithms and/or one or more plane fitting techniques to identify and/or remove the one or more points associated with the ground of the marshaling environment. The points associated with the one or more points that are not associated with the ground of the marshaling environment are retained for further processing by the processor 206, for example. It is understood that while the one or more algorithms can be a random sample consensus (RANSAC) algorithm, any algorithm can be used.

As an additional example, the application of the clustering filter to any of the one or more data sets is used to group points from any of the LIDAR point clouds 202a-202c into clusters. For example, each of the clusters can represent a distinct object and/or part of an object within the marshaling environment. As an example, the application of the clustering filter is performed using one or more algorithms and/or one or more Euclidean cluster extraction techniques to identify one or more clusters of points within any of the LIDAR point clouds 202a-202c that are spatially close to one another. It is understood that while the one or more algorithms can be a density-based spatial clustering of applications with noise (DBSCAN) algorithm, any algorithm can be used. It is understood that the application of the clustering filter can enable the processor 206 to distinguish between different entities within the marshaling environment. For example, the different entities can be any object within the marshaling environment such as one or more vehicles, pedestrians, and/or other objects within the marshaling environment.

In one or more embodiments, the processor 206 is configured to dynamically (e.g., in real-time) detect and generate the one or more bounding boxes around the one or more objects at operation 218. As an example, the one or more objects are three-dimensional and exist within the marshaling environment. In one or more examples, the processor 206 is configured to utilize any form of neural networking or deep learning modeling to process the one or more filtered versions of the concatenated data sets. It is understood that in an instance wherein a deep learning model is utilized to detect and generate the one or more bounding boxes, the processor 206 can train the deep learning model across various configurations to maintain robust detection capabilities that may overcome a malfunction associated with any of the plurality of sensors 120. In one or more examples, the processor 206 is configured to determine whether a detected object of the one or more objects is unclassified or classified. It is understood that a classified object of the one or more objects may correspond to an identifiable object that the deep learning model is trained to recognize such as, but not limited to, a vehicle, a pedestrian, or any other specific objects. It is also understood that an unclassified object of the one or more objects may correspond to any object that is not identifiable by the deep learning model. In one or more examples, the one or more bounding boxes (e.g., one or more bounding boxes 228a and 228b) can be generated at operation 220 to highlight one or more identifiable objects of the one or more objects. In one or more examples, the bounding box 228a indicates a vehicle identified as an object within the marshaling environment. As yet another example, the bounding box 228a generated at operation 220 can include an arrow 230 indicative of a heading associated with each of the identified vehicles. As yet another example, the bounding box 228b indicates a pedestrian identified as an object within the marshaling environment. As another example, and in a case wherein no objects of the one or more objects are identifiable, no bounding boxes are generated as is depicted at operation 222.

In one or more embodiments, the processor 206 is also configured to generate an output 224 that can include a two-dimensional occupancy map at operation 226 by merging both the classified detected object data (e.g., represented at operation 222) and the unclassified detected object data (e.g., represented at operation 220). However, it is understood that the occupancy map may also be generated in a three-dimensional format as well. It is also understood that the occupancy map functions to highlight specific areas within the marshaling environment that are occupied, available, and/or drivable, for example. It is further understood that the occupancy map may function to highlight specific areas within the marshaling environment for any reason and that in highlighting specific areas within the marshaling environment efficiency and/or safety within the marshaling environment is enhanced.

In one or more embodiments, the processor 206 is further configured to integrate the occupancy map with a vehicle control system at operation 232. In one or more examples, the integration of the occupancy map with the vehicle control system is performed through a wireless means via the exchange of one or more infrastructure marshaling messages (IMMs) and vehicle marshaling messages (VMMs). It is understood that the integration of the occupancy map with the vehicle control system enables the infrastructure system to manage movement of one or more automated vehicles in real-time (e.g., via a marshaling means). It is also understood that the real-time management of the movement of the one or more automated vehicles enhances efficiency and/or safety within the marshaling environment.

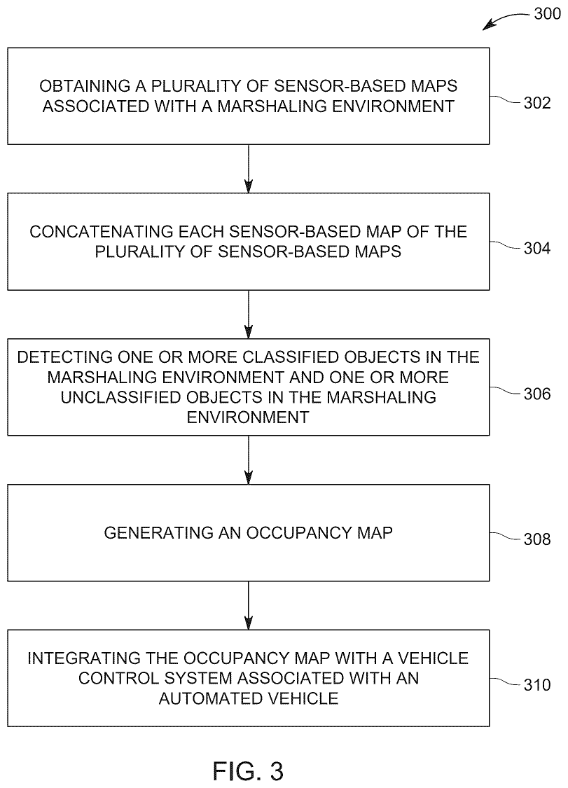

FIG. 3 is a flowchart illustrating an example method 300 for detecting and/or classifying one or more objects within a marshaling environment. At operation 302, an infrastructure system is configured to obtain a plurality of sensor-based maps associated with the marshaling environment. For example, the plurality of sensor-based maps is obtained by a plurality of sensors (e.g., the plurality of sensors 120) of the infrastructure system. As another example, each sensor-based map of the plurality of sensor-based maps is based on data obtained from a different sensor of the plurality of sensors.

At operation 304, the infrastructure system is also configured to concatenate each sensor-based map of the plurality of sensor-based maps. In one or more examples, the concatenation of each sensor-based map of the plurality of sensor-based maps includes an application of a filter to one or more data points associated with each sensor-based map of the plurality of sensor-based maps. As another example, the filter includes a voxel filter, a height filter, a regional filter, a ground segmentation filter, a clustering filter, or a combination thereof. In one or more examples, the concatenation of each sensor-based map of the plurality of sensor-based maps also includes merging one or more data points associated with each sensor-based map of the plurality of sensor-based maps and forming a comprehensive view of the marshaling environment. As an example, the formation of the comprehensive view of the marshaling environment is based on the merging of the one or more data points associated with each sensor-based map of the plurality of sensor-based maps.

At operation 306, the infrastructure system is further configured to detect one or more classified objects and/or one or more unclassified objects in the marshaling environment. For example, the detection of the one or more classified objects and/or the one or more unclassified objects is performed by one or more algorithms associated with the infrastructure system. As another example, the detection of the one or more classified objects and/or the one or more unclassified objects is based on the concatenation of each sensor-based map of the plurality of sensor-based maps. In one or more examples, the detection of the one or more classified objects and/or the one or more unclassified objects includes generating one or more virtual bounding boxes corresponding to each of the one or more classified objects and the one or more unclassified objects.

At operation 308, the infrastructure system is additionally configured to generate an occupancy map based on object data associated with each of the one or more classified objects and the one or more unclassified objects. In one or more examples, the generation of the occupancy map includes merging the one or more classified objects with the one or more unclassified objects. At operation 310, the infrastructure system is also configured to integrate the occupancy map with a vehicle control system associated with an automated vehicle. For example, the integration of the occupancy map with the vehicle control system enables the infrastructure system to autonomously control the automated vehicle in real-time.

In one or more embodiments, the infrastructure system is configured to determine a desired spatial configuration corresponding to a field of view associated with each sensor of the plurality of sensors and an optimal placement of each sensor of the plurality of sensors. The infrastructure system is also configured to calibrate each sensor of the plurality of sensors based on the desired spatial configuration and the optimal placement of each sensor of the plurality of sensors. In one or more embodiments, the infrastructure system is configured to identify one or more zones of the marshaling environment. The infrastructure system is further configured to filter a field of view associated with each sensor of the plurality of sensors based on the identification of the one or more zones of the marshaling environment.

Thus, one or more examples of the present disclosure provide a means for detecting and/or classifying one or more objects within an environment through the utilization of machine learning and the application of various filters to an initial set of one or more images of the environment. The processes described herein ultimately provide a simplified representation of the environment to a user so that the one or more objects can be easily identifiable and so that an automated vehicle can be caused to navigate the environment with more accuracy and precision.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
obtaining, by a plurality of sensors of an infrastructure system, a plurality of sensor-based maps associated with a marshaling environment;
concatenating each sensor-based map of the plurality of sensor-based maps;
detecting, by one or more algorithms associated with the infrastructure system, one or more classified objects in the marshaling environment and one or more unclassified objects in the marshaling environment based on the concatenation of each sensor-based map of the plurality of sensor-based maps;
generating an occupancy map based on object data associated with each of the one or more classified objects and the one or more unclassified objects; and
integrating the occupancy map with a vehicle control system associated with an automated vehicle, wherein the integration of the occupancy map with the vehicle control system enables the infrastructure system to autonomously control the automated vehicle in real-time.

2. The method of claim 1, further comprising:
determining a desired spatial configuration corresponding to a field of view associated with each sensor of the plurality of sensors and an optimal placement of each sensor of the plurality of sensors; and
calibrating each sensor of the plurality of sensors based on the desired spatial configuration and the optimal placement of each sensor of the plurality of sensors.

3. The method of claim 1, further comprising:
identifying one or more zones of the marshaling environment; and
filtering a field of view associated with each sensor of the plurality of sensors based on the identification of the one or more zones of the marshaling environment.

4. The method of claim 1, wherein each sensor-based map of the plurality of sensor-based maps is based on data obtained from a different sensor of the plurality of sensors.

5. The method of claim 1, wherein the concatenation of each sensor-based map of the plurality of sensor-based maps comprises:
applying a filter to one or more data points associated with each sensor-based map of the plurality of sensor-based maps, wherein the filter includes a voxel filter, a height filter, a regional filter, a ground segmentation filter, a clustering filter, or a combination thereof.

6. The method of claim 1, wherein the concatenation of each sensor-based map of the plurality of sensor-based maps comprises:
merging one or more data points associated with each sensor-based map of the plurality of sensor-based maps; and
forming a comprehensive view of the marshaling environment based on the merging of the one or more data points associated with each sensor-based map of the plurality of sensor-based maps.

7. The method of claim 1, wherein the detection of each of the one or more classified objects and the one or more unclassified objects further comprises:
generating one or more virtual bounding boxes corresponding to each of the one or more classified objects and the one or more unclassified objects.

8. The method of claim 1, wherein the generation of the occupancy map further comprises:
merging the one or more classified objects with the one or more unclassified objects.

9. A system comprising:
an infrastructure system configured to:
obtain, from a plurality of sensors of the infrastructure system, a plurality of sensor-based maps associated with a marshaling environment,
concatenate each sensor-based map of the plurality of sensor-based maps,
detect, by one or more algorithms associated with the infrastructure system, one or more classified objects in the marshaling environment and one or more unclassified objects in the marshaling environment based on the concatenation of each sensor-based map of the plurality of sensor-based maps,
generate an occupancy map based on object data associated with each of the one or more classified objects and the one or more unclassified objects, and
integrate the occupancy map with a vehicle control system associated with an automated vehicle, wherein the integration of the occupancy map with the vehicle control system enables the infrastructure system to autonomously control the automated vehicle in real-time during marshaling of the automated vehicle; and
the automated vehicle configured to:
receive, from the infrastructure system, one or more marshaling commands associated with the autonomous control of the automated vehicle, and
proceed to a waypoint within the marshaling environment based on the one or more marshaling commands.

10. The system of claim 9, wherein the infrastructure system is further configured to:
determine a desired spatial configuration corresponding to a field of view associated with each sensor of the plurality of sensors and an optimal placement of each sensor of the plurality of sensors; and
calibrate each sensor of the plurality of sensors based on the desired spatial configuration and the optimal placement of each sensor of the plurality of sensors.

11. The system of claim 9, wherein the infrastructure system is further configured to:
identify one or more zones of the marshaling environment; and
filter a field of view associated with each sensor of the plurality of sensors based on the identification of the one or more zones of the marshaling environment.

12. The system of claim 9, wherein each sensor-based map of the plurality of sensor-based maps is based on data obtained from a different sensor of the plurality of sensors.

13. The system of claim 9, wherein the infrastructure system configured to concatenate each sensor-based map of the plurality of sensor-based maps is further configured to:
apply a filter to one or more data points associated with each sensor-based map of the plurality of sensor-based maps, wherein the filter includes a voxel filter, a height filter, a regional filter, a ground segmentation filter, a clustering filter, or a combination thereof.

14. The system of claim 9, wherein the infrastructure system configured to concatenate each sensor-based map of the plurality of sensor-based maps is further configured to:
merge one or more data points associated with each sensor-based map of the plurality of sensor-based maps; and
form a comprehensive view of the marshaling environment based on the merging of the one or more data points associated with each sensor-based map of the plurality of sensor-based maps.

15. The system of claim 9, wherein the infrastructure system configured to detect each of the one or more classified objects and the one or more unclassified objects is further configured to:
generate one or more virtual bounding boxes corresponding to each of the one or more classified objects and the one or more unclassified objects.

16. The system of claim 9, wherein the infrastructure system configured to generate the occupancy map is further configured to:
merge the one or more classified objects with the one or more unclassified objects.

17. One or more non-transitory computer-readable media storing processor-executable instructions that, when executed by at least one processor, cause the at least one processor to:
obtain a plurality of sensor-based maps associated with a marshaling environment;
concatenate each sensor-based map of the plurality of sensor-based maps;
detect one or more classified objects in the marshaling environment and one or more unclassified objects in the marshaling environment based on the concatenation of each sensor-based map of the plurality of sensor-based maps;
generate an occupancy map based on object data associated with each of the one or more classified objects and the one or more unclassified objects; and
integrate the occupancy map with a vehicle control system associated with an automated vehicle, wherein the integration of the occupancy map with the vehicle control system enables an infrastructure system to autonomously control the vehicle in real-time.

18. The one or more non-transitory computer-readable media of claim 17, wherein the at least one processor caused to concatenate each sensor-based map of the plurality of sensor-based maps is further caused to:
merge one or more data points associated with each sensor-based map of the plurality of sensor-based maps; and
form a comprehensive view of the marshaling environment based on the merging of the one or more data points associated with each sensor-based map of the plurality of sensor-based maps.

19. The one or more non-transitory computer-readable media of claim 17, wherein the at least one processor caused to concatenate each sensor-based map of the plurality of sensor-based maps is further caused to:
apply a filter to one or more data points associated with each sensor-based map of the plurality of sensor-based maps, wherein the filter includes a voxel filter, a height filter, a regional filter, a ground segmentation filter, a clustering filter, or a combination thereof.

20. The one or more non-transitory computer-readable media of claim 17, wherein the at least one processor caused to detect each of the one or more classified objects and the one or more unclassified objects is further caused to:
generate one or more virtual bounding boxes corresponding to each of the one or more classified objects and the one or more unclassified objects.
